(19) United States
(12) Patent Application Publication
(10) Pub. No.: US 2018/0004202 A1
(43) Pub. Date: Jan. 4, 2018

(54) ROBOT FLEET DISPATCH REQUEST SYSTEM

(71) Applicant: Innovation Matrix, Inc., Santa Clara, CA (US)

(72) Inventors: Eimei Ming Onaga, Los Altos, CA (US); Mark Fumio Onaga, Los Altos, CA (US)

(21) Appl. No.: 15/636,289

(22) Filed: Jun. 28, 2017

Related U.S. Application Data
(60) Provisional application No. 62/357,759, filed on Jul. 1, 2016.

(51) Int. Cl. G05D 1/00; G06Q 10/06; G05D 1/02; G06Q 30/02; H04L 29/08

(52) U.S. Cl. CPC G05D 1/0027; G06Q 30/0283; H04L 67/125; G05D 1/0297; G06Q 10/06315; Y10S 901/01

(57) ABSTRACT

Robot dispatch request systems can be used to control one or more robotic fleets. A robot dispatch request system can provide a user interface through which a user can send a service request to utilize at least one robot-usage-as-a-service (RaaS). Each RaaS can be implemented by one or more robotic fleets, and each robotic fleet can include one or more robots. Robotic fleets can be comprised of a set of homogeneous robots or a set of heterogeneous robots. A service request may not specify a particular robotic fleet to complete the requested service. In such instances, the robot dispatch request system can determine an optimal robotic fleet (or an optimal combination of multiple robotic fleets) to complete the requested service, and then request that a fleet management system select one or more robots in the determined robotic fleet to perform the requested service.

### CROSS-REFERENCE TO RELATED APPLICATIONS

This application claims priority to U.S. Provisional Patent Application No. 62/357,759, titled “Robot Fleet Dispatch Request System” and filed on Jul. 1, 2016, which is incorporated by reference herein in its entirety.

### TECHNICAL FIELD

At least one embodiment of this disclosure relates generally to robotic control systems, and in particular to dispatching robot fleets.

### BACKGROUND

A robot is a mechanical or otherwise artificial agent capable of carrying out a complex series of actions. More specifically, a robot is usually an electromechanical machine that is guided by a computer program or electronic circuitry. Robots can be autonomous or semiautonomous. Robots can also come in various shapes and sizes. For example, a robot could be in the form of a vehicle, a humanoid, an appendage, an arbitrarily shaped machine, or any combination thereof.

In some cases, multiple robots can be managed as a single fleet. For example, a group of construction robots can deliver construction material from one place to another in unison. However, conventional fleet management systems have a rigid set of commands that are only able to service a single predefined application and a single predefined client, and hence limit the use of a fleet of robots to the predefined application and the predetermined client.

### DISCLOSURE OVERVIEW

Various embodiments pertain to robot dispatch request systems for controlling one or more robotic fleets. A robot dispatch request system can provide a user interface through which a user can send a service request to utilize at least a robot-usage-as-a-service (RaaS). Each RaaS can be implemented by one or more robotic fleets (e.g., each robotic fleet can include of a set of homogeneous robots or a set of heterogeneous robots). In some embodiments, a service request does not specify a particular robotic fleet to complete the requested service. Accordingly, in these embodiments, the robot dispatch request system can determine an optimal robotic fleet (or an optimal combination of multiple robotic fleets) to complete the requested service and request that a fleet management system select one or more robots in the determined robotic fleet to perform the requested service.

The robot dispatch request system can be implemented using a computer system that includes one or more computing devices (e.g., computer servers, desktop computers, laptop computers). For example, some embodiments of the robot dispatch request system include one or more remote cloud-based servers, one or more local area network (LAN) servers, or a combination thereof. The robot dispatch request system can be coupled to one or more agent applications running on client devices. In one example, the agent applications include a mobile application running on a general-purpose computing device (e.g., a mobile phone, a laptop computer, a desktop computer, a tablet, etc.). A computing device can be considered “general purpose” if it implements a general-purpose operating system that supports one or more third-party applications to run thereon. In another example, the agent applications can include a web application provided via a web server and accessible via a browser application running on a client device.

In some embodiments, the robotic dispatch request system interfaces with multiple robotic fleet management systems. For example, the robotic fleet management systems can be independent fleet management systems from different vendors. As another example, the robot fleet management systems can be independent fleet management systems associated with different deployment environments/entities. Each independent fleet management system can manage one or more robotic fleets that include robots of a homogeneous robotic type, robots of various independent robotic types, or robots of different robotic types that are interoperable (e.g., interchangeable and capable of performing overlapping functions). The robotic dispatch request system can also monitor the scheduling and statuses of deployed robots and/or robotic fleets corresponding to various service requests and RaaSs.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references indicate similar elements.

FIG. 1 is a block diagram illustrating an operating environment of a robot dispatch request system, in accordance with various embodiments.

FIG. 2 is a block diagram illustrating an example of a robot dispatch request system, in accordance with various embodiments.

FIG. 3 is a flow chart of a method of operating a robot dispatch request system, in accordance with various embodiments.

FIG. 4 is a block diagram of an example of a computing device, which may represent one or more computing device or server described herein, in accordance with various embodiments.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

Introduced here are robot dispatch request systems for controlling one or more robotic fleets. Each robotic fleet can include a set of homogeneous robot(s) (e.g., robots of the same type) or a set of heterogeneous robot(s) (e.g., robots of different types).

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The terms “connected,” “coupled,” or any variant thereof is intended to include any connection or coupling, either direct or indirect, between two or more elements. The coupling/connection can be physical, logical, or a combination thereof. For example, two devices may be communicatively coupled to one another despite not sharing a physical connection.

When used in reference to a list of multiple items, the word “or” is intended to cover all of the following interpretations: any of the items in the list, all of the items in the list, and any combination of items in the list.

### Technology Overview

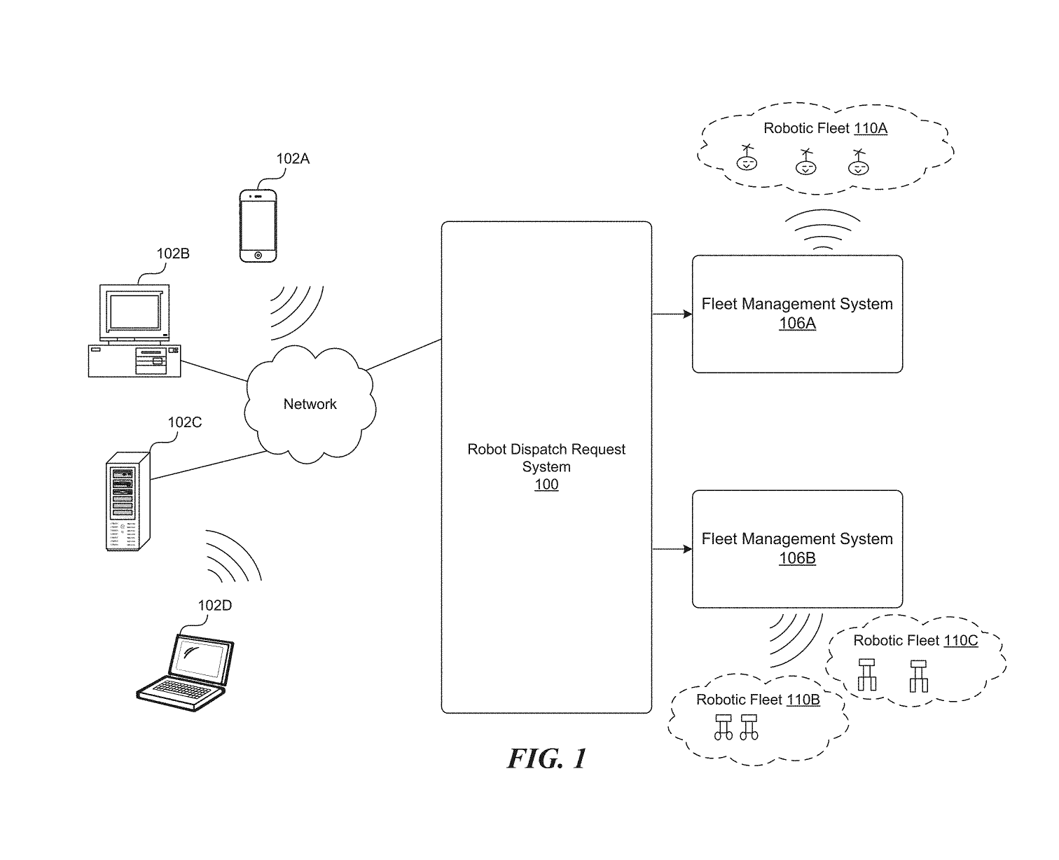

FIG. 1 is a block diagram illustrating an operating environment of a robot dispatch request system 100, in accordance with various embodiments. The robot dispatch request system 100 can provide a robot dispatch service responsive to a user inputting a request for the use of a robot service through a mobile application, a web application, desktop software program, or over-the-top (OTT) application. The request can be submitted using an interface that is accessible via a mobile phone, tablet computer, personal computer, game console (e.g., Sony PlayStation® or Microsoft Xbox®), wearable electronic device (e.g., a watch or fitness tracker), network-connected (“smart”) devices, virtual/augmented reality systems (e.g., Oculus Rift® or Microsoft Hololens®), etc.

The robot dispatch request system 100 can direct the request to a particular fleet management system that manages and directs the activity of at least one fleet of robots. A fleet of robots can be implemented, for example, in a public space, such as an airport or a train station. A fleet of robots could also be implemented in a private space, such as a school or corporate enterprise. Accordingly, the robot dispatch request system 100 may be suitable for outdoor robotic systems, indoor robotic systems, or both.

The robot dispatch request system 100 can consolidate service requests from one or more client devices 102 (e.g., a mobile device 102A, a personal computer 102B, a computer server 102C, a laptop 102D, etc., which are collectively referred to as the “client devices 102”) and determine how to fulfill these service requests utilizing one or more fleet management systems 106 (e.g., a fleet management system 106A, a fleet management system 106B, etc., which are collectively referred to as the “fleet management systems 106”). For example, the fleet management system 106A can be responsible for controlling/managing a robotic fleet 110A, and the fleet management system 106B can be responsible for controlling/managing a robotic fleet 110B and a robotic fleet 110C. Those skilled in the art will recognize that a single fleet management system could be responsible for controlling/managing any number of robotic fleets having any number of robots.

The robot dispatch request system 100 generates and provides one or more user interfaces to the client devices 102. The client devices 102 can include one or more general-purpose computing devices (e.g., computing devices with general-purpose operating systems). Each user interface can be tailored differently for different types of client devices 102 and/or different user profiles. For example, a user interface may include elements that vary based on the type of tasks the robotic fleet(s) can complete, the environment where the robotic fleet(s) reside, the permissions associated with the individual accessing the user interface (e.g., some individuals may only be permitted to authorize certain tasks), etc. In some embodiments, a user interface of the robot dispatch request system 100 is a web interface implemented via a web server of the robot dispatch request system 100. In some embodiments, a user interface of the robot dispatch request system 100 is implemented by a mobile application running on at least one of the client devices 102.

The robot dispatch request system 100 can simultaneously or sequentially interface with the fleet management systems 106. A fleet management system can provide one or more RaaSs, where each RaaS is representative of a particular robot usage application (e.g., surveillance, transport, security, etc.). A fleet management system can provide one or more robotic functions to be used by users of the robot dispatch request system 100. Thus, the robot dispatch request system 100 can act as a direct client of the fleet management systems 106 and as an agent for the users operating the client devices 102.

In some embodiments, the robot dispatch request system 100 interfaces with the fleet management systems 106 via one or more application programming interfaces (APIs). In some cases, a particular API is implemented in a fleet management system, and the robot dispatch request system 100 is configured to communicate with the particular API via a set of custom commands defined in the fleet management system. In some cases, a platform API is implemented on the robot dispatch request system 100, and one or more robot fleet management systems can communicate with the platform API via a set of custom commands defined in the platform API. For example, in these cases, a software development kit (SDK) can be provided to the fleet management systems 106 to generate the custom commands that the platform API understands.

In various embodiments, the client devices 102 can be oblivious of the existence of the fleet management systems 106. That is, when a client device (e.g., mobile phone 102A) makes a service request, not only is the client device unaware of which robot or robotic fleet is to be assigned to perform the requested service, but the client device is also unaware of what vendor/computer system would be responsible for providing/hosting the fleet management system. In various embodiments, the fleet management systems 106 can be oblivious of the existence of the client devices 102. Because of the described architecture, any number of client devices 102 and/or fleet management systems 106 can be added in real time to the robot dispatch request system 100 without affecting the real-time operation of the robot dispatch request system 100. Such an architecture also allows client devices 102 and fleet management systems 106 to be removed and/or modified without affecting the functionality of the robot dispatch request system 100.

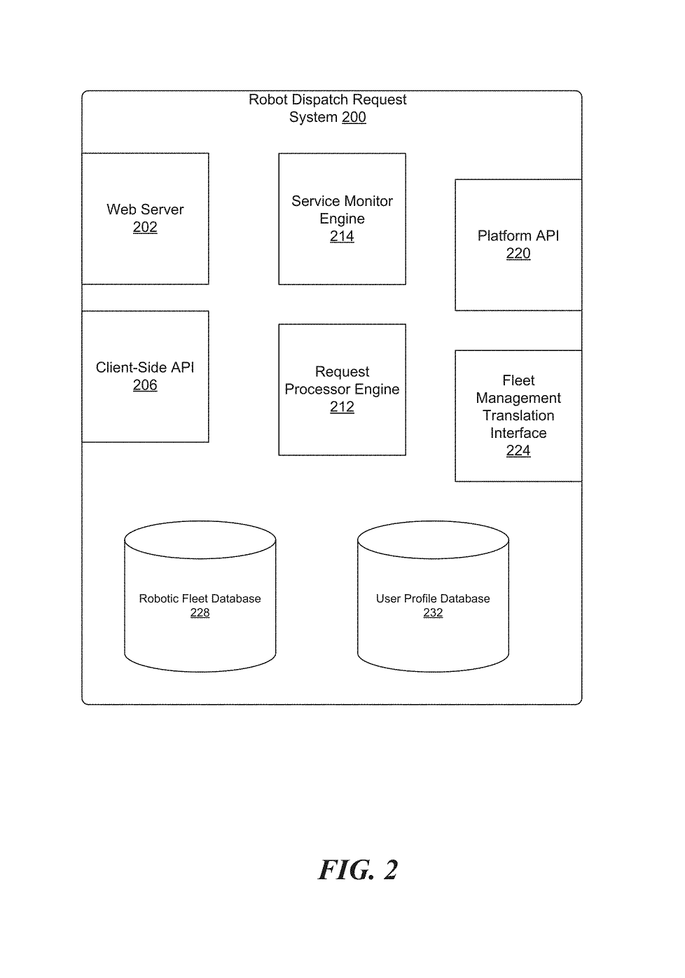

FIG. 2 is a block diagram illustrating an example of a robot dispatch request system 200 (e.g., the robot dispatch request system 100 of FIG. 1), in accordance with various embodiments. The robot dispatch request system 200 includes a web server 202, a client-side API 206, a request processor engine 212, a service monitor engine 214, a platform API 220, and a fleet management translation interface 224. Other embodiments of the robot dispatch request system 200 can include some or all of these components, as well as other components not shown here.

The web server 202 can generate a web interface (e.g., via one or more webpages) to enable client devices (e.g., the client devices 102 of FIG. 1) to interact with the robot dispatch request system 200 Likewise, the client-side API 206 provides an API that enables one or more agent applications running on at least one of the client devices to communicate with the robot dispatch request system 200. The agent application(s) can provide an application-implemented user interface on the client devices with similar functionalities as the web interface. For example, the web interface and/or the application-implemented user interface (collectively referred to as the “user interfaces”) can capture a service request from a user of a client device, and then propagate the service request to the request processor engine 212. The user interfaces can be used to review the status of a commissioned robot, manage a user profile, collect user input to generate a service request (e.g., including selecting an RaaS type for the service request), etc.

In response to receiving a service request (e.g., via the web server 202 and/or the client-side API 206), the request processor engine 212 can select and assign a fleet management system to handle the service request. In some embodiments, the fleet management system, in turn, can select one or more robots from its one or more robotic fleets using logic independent of the robot dispatch request system 200. Robot(s) could be selected from a single fleet or from amongst multiple fleets.

In some embodiments, the request processor engine 212 specifically requests a robotic fleet known by the robot dispatch request system 200. For example, the robot dispatch request system 200 can include a robotic fleet database 228. The robotic fleet database 228 can maintain a list of robotic fleets and functions and capabilities of each robotic fleet. The robotic fleet database 228 can also maintain an availability schedule associated with the robotic fleets. The robotic fleet database 228 advantageously enables the request processor engine 212 to obtain information associated with the robotic fleets and/or fleet management systems without having to query the fleet management systems in real time.

A service request can define the requested service. For example, the service request can include a requested time (e.g., a starting time, an ending time, a maximum duration, a minimum duration, or any combination thereof), a requested location (e.g., a specific building, global positioning system (GPS) coordinates, a zip code, or any combination thereof), a requested target (e.g., an object identifier associated with the object for a robotic fleet to deliver, carry, retrieve, capture, monitor, etc.), service request logic parameters (e.g., contextual conditionals that need to be satisfied before executing or terminating performance of a service), a service subject (e.g., a user profile for whom the service is requested), or any combination thereof. In some embodiments, the request processor engine 212 selects a robotic fleet based on geolocation information associated with the service request. For example, the request processor engine 212 can determine a list of available robotic fleets that satisfy the functional needs of the service request and are available at the requested time.

The service monitor engine 214 can monitor the progression of each service request. In some embodiments, the service monitor engine 214 generates an interactive panel in the user interfaces to enable the users operating the client devices to monitor the progression of their service requests.

The platform API 220 and the fleet management translation interface 224 represent different ways that the robot dispatch request system 200 can connect with fleet management systems. For example, with the platform API 220, the robot dispatch request system 200 provides a programming interface to process commands and/or messages received from or transmitted to the fleet management systems. In this example, the platform API 220 defines a set of custom commands. The syntax of the set of custom commands is then provided (e.g., via software development kits (SDKs)) to one or more fleet management systems. In another example, a fleet management system provides a programming interface to process commands and/or messages received from or transmitted to the robot dispatch request system 200. In this example, the fleet management system defines a set of custom commands. The syntax of the set of custom commands is accessible to the fleet management translation interface 224. The fleet management translation interface 224 can receive a command/message from the request processor engine 212 and/or the service monitor engine 214, translate that into a command/message consistent with the fleet management system, and then send the translated command to the fleet management system. Likewise, the fleet management translation interface 224 can receive a message or command from the fleet management system, translate that into a command consistent with the engines of the robot dispatch request system 200, and pipe the translated command to the appropriate destination(s) (e.g., engines).

The robot dispatch request system 200 can include a user profile database 232. The user profile database 232 can maintain a record of one or more user profiles associated with the client devices. Each user profile can include an access control profile, a user attribute profile, a usage accounting profile, a preference profile, or any combination thereof. The access control profile can specify what types of robotic fleets or what functionalities of robotic fleets are accessible to a user profile. Said another way, the access control profile can set/define permissions for which robotic fleets and/or functionalities are accessible to the user profile. The access control profile can be set by the robot dispatch request system 200. For example, a user associated with the user profile can view the access control profile freely, but may only be able to modify the access control profile upon authorization by the robot dispatch request system 200. The user attribute profile can store attribute data associated with a user. In some embodiments, the attribute data is provided to the request processor engine 212 as an input to better select the optimal robotic fleet (and associated fleet management system) to complete a service request. In some embodiments, the attribute data is provided to the selected fleet management system as an input such that the fleet management system can better select the optimal robot(s) to complete a service request. For example, the attribute data can include user location data, client device identity data, user social network data, or any combination thereof.

The usage accounting profile maintains a log record of service requests sent by the user profile and/or periods of time that specific RaaSs are accessible to the user profile (e.g., according to the access control profile). In some embodiments, the robot dispatch request system 200 can use the usage accounting profile to electronically charge a user's financial account associated with the usage accounting profile. The preference profile includes configurable parameters in previous service requests generated by the user profile. The preference profile enables the request processor engine 212 to automatically define parameters in future service requests based on the stored configurable parameters. The preference profile can be user-reported and/or automatically configured based on statistical summaries or results of pattern recognition (e.g., via machine learning algorithms) of previous service requests.

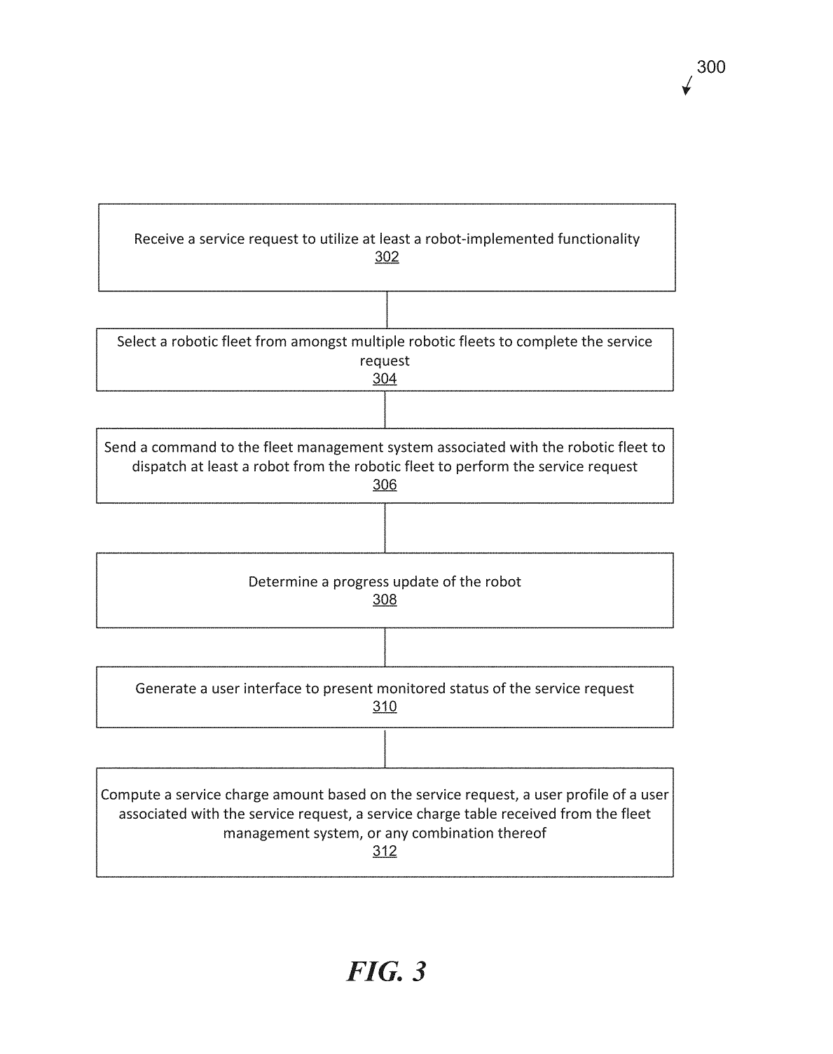

FIG. 3 is a flow chart of a method 300 of operating a robot dispatch request system (e.g., the robot dispatch request system 100 of FIG. 1 or the robot dispatch request system 200 of FIG. 2), in accordance with various embodiments. At step 302, the robot dispatch request system receives (e.g., via the web server 202 or the client-side API 206) a service request to utilize at least a robot-implemented functionality. For example, a web interface or an application-implemented user interface can collect user inputs to form the service request. The service request can be for object transport, personnel transport, photography, videography, surveillance, concierge, rescue, security, entertainment, repair, or any combination thereof. The service request can include geolocation information of a requesting user. In some embodiments, the service request will call for multiple robot-implemented functionalities.

At step 304, the robot dispatch request system selects a robotic fleet from amongst multiple robotic fleets to complete the service request. Selection of the robotic fleet can be based on one or more parameters of the service request, a user profile of a user associated with the service request, a fleet profile associated with the robotic fleet, or any combination thereof. In response to selecting the robotic fleet, the robot dispatch request system can turn on an electronic lock to prevent the robotic fleet from servicing other requests. In some embodiments, the robot dispatch request system selects the robotic fleet independent of the fleet management system. In some embodiments, the robot dispatch request system selects the robotic fleet by first selecting the fleet management system from amongst multiple fleet management systems, and then requesting a robotic fleet recommendation from the fleet management system.

At step 306, the robot dispatch request system sends a command to the fleet management system associated with the robotic fleet to dispatch (e.g., at the fleet management system's own choosing, per specific request indicated by the service request, or as determined by a request processor engine of the robot dispatch request system) at least a robot from the robotic fleet to perform the service request. The robot dispatch request system can send the geolocation information in the service request to the fleet management system such that the dispatched robot can be sent to a geographical location in accordance with the geolocation information.

At step 308, the robot dispatch request system can determine a progress update of the robot. In one example, the robot dispatch request system can obtain the progress update from the fleet management system. In another example, the robot dispatch request system can update the status by comparing a geolocation of a requesting device and the robot as reported from the fleet management system. If the geolocations of the requesting device and the robot are the same or similar, then the robot dispatch request system can determine that the requested service is about to begin and that the robot has “arrived.” In some embodiments, the robot dispatch request system compares a service “origin” location specified in the service request against the location of the robot to determine whether the requested service is about to begin. In some embodiments, the robot dispatch request system compares a service “destination” location specified in the service request against the location of the robot to determine whether the requested service has ended. The robot dispatch request system can release the electronic lock of step 304 after determining the completion of the service request based on the progress update. Moreover, as noted above, the robot dispatch request system can simultaneously or sequentially determine progress updates for multiple robots if the service request requires multiple robots.

At step 310, the robot dispatch request system generates a user interface (e.g., the same user interface that collected the information that triggered the service request) to present (e.g., display or audibly describe) monitored status of the service request. The robot dispatch request system can display a status of the assigned robotic fleet on a map provided by the user interface. The robot dispatch request system can display the availability of all robotic fleets available to the robot dispatch request system or individual robots in the selected robotic fleet. In some embodiments, the robot dispatch request system can request, via the user interface, a user confirmation of arrival of the robot or completion of the service request.

At step 312, the robot dispatch request system can compute a service charge amount based on the service request, a user profile of a user associated with the service request, a service charge table received from the fleet management system, or any combination thereof. The service charge can be triggered in response to receiving the service request or in response to determining that the service request has been completed. More specifically, computing the service charge can include determining an amount of usage of each robot in a robotic fleet assigned to complete the service request, calculating a total usage of the robot(s) used to complete the task(s) required by the service request, looking up a user profile and/or membership information associated with the individual who submitted the service request, determining an applicable rate (e.g., based on the user profile, membership information, and/or a service charge table received from the fleet management system), and automatically generating a total charge amount associated with the completion of the assignment for the individual. The total charge amount can be posted to a user interface for review by the individual. Additionally or alternatively, the total charge amount may be delivered in the form of an email message, a text message, a push notification, an automated voice message, etc.

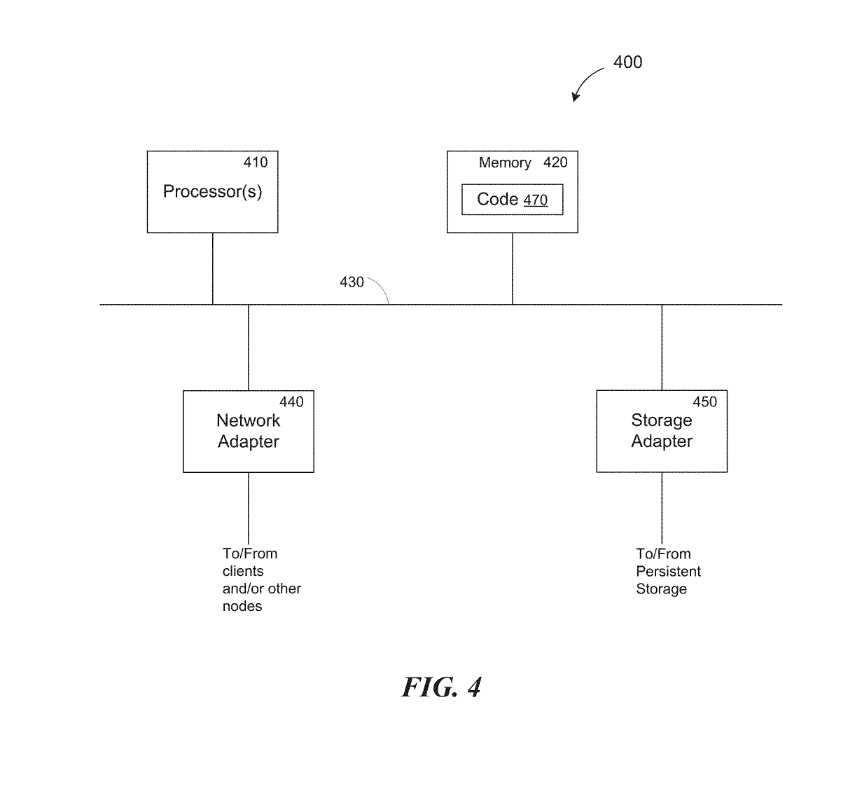

FIG. 4 is a block diagram of an example of a computing device 400, which may represent any of the computing devices (e.g., mobile devices, personal computers, computer servers, laptops) described herein, in accordance with various embodiments. The computing device 400 can be one or more computing devices in the robot dispatch request system 200 of FIG. 2 or in the operating environment of the robot dispatch request system 100 of FIG. 1. The computing device 400 can implement at least partially the method 300 of FIG. 3. The computing device 400 includes one or more processors 410 and memory 420 coupled to an interconnect 430. The interconnect 430 shown in FIG. 4 is an abstraction that represents any one or more separate physical buses, point-to-point connections, or both connected by appropriate bridges, adapters, or controllers. The interconnect 430, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The processor(s) 410 is/are the central processing unit (CPU) of the computing device 400 and thus controls the overall operation of the computing device 400. In certain embodiments, the processor(s) 410 accomplishes this by executing software or firmware stored in memory 420. The processor(s) 410 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 420 is or includes the main memory of the computing device 400. The memory 420 represents any form of random access memory (RAM), read-only memory (ROM), flash memory, or the like, or a combination of such devices. In use, the memory 420 may contain code 470 containing instructions according to the robot dispatch request disclosed herein.

Also connected to the processor(s) 410 through the interconnect 430 are a network adapter 440 and a storage adapter 450. The network adapter 440 provides the computing device 400 with the ability to communicate with remote devices over a network, and the network adapter 440 may be, for example, an Ethernet adapter or Fibre Channel adapter. The network adapter 440 may also provide the computing device 400 with the ability to communicate with other computing devices. The storage adapter 450 enables the computing device 400 to access a persistent storage, and the storage adapter 450 may be, for example, a Fibre Channel adapter or SCSI adapter.

The code 470 stored in memory 420 may be implemented as software and/or firmware to program the processor(s) 410 to carry out actions described above. In certain embodiments, such software or firmware may be initially provided to the computing device 400 by downloading it from a remote system through the computing device 400 (e.g., via the network adapter 440).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

What is claimed is:

1. A method comprising:
receiving, by a computer-implemented dispatch system, a service request to utilize at least a robot-implemented functionality;
selecting, by the computer-implemented dispatch system, a robotic fleet from amongst multiple robotic fleets and a fleet management system associated with the robotic fleet to complete the service request;
dispatching, by the computer-implemented dispatch system, at least a robot from the robotic fleet by sending a command to the fleet management system associated with the robotic fleet;
obtaining, by the computer-implemented dispatch system, a progress update of the robot from the fleet management system; and
generating, by the computer-implemented dispatch system, a user interface to monitor a status of the service request.

2. The method of claim 1, further comprising:
in response to receiving the service request, computing, by the computer-implemented dispatch system, a service charge amount based on the service request by
determining an amount of usage of each robot in the robotic fleet dispatched to complete the service request,
calculating a total usage of each robot in the robotic fleet used to complete one or more tasks required by the service request,
retrieving a user profile or membership information associated with an individual responsible for submitting the service request,
determining an applicable rate based on the user profile, the membership information, a service charge table received from the fleet management system, or some combination thereof, and
automatically generating the service charge amount associated with the completion of the assignment for the individual.

3. The method of claim 1, wherein selecting the robotic fleet is based on one or more parameters of the service request, a user profile of a user associated with the service request, a fleet profile associated with the robotic fleet, or any combination thereof.

4. The method of claim 1, further comprising:
in response to said selecting, setting, by the computer-implemented dispatch system, an electronic lock to prevent the robotic fleet from servicing other requests.

5. The method of claim 4, further comprising:
releasing, by the computer-implemented dispatch system, the electronic lock responsive to determining the service request has been completed based on the progress update.

6. The method of claim 1, wherein the service request is for object transport, personnel transport, photography, videography, surveillance, concierge, rescue, security, entertainment, repair, or any combination thereof.

7. The method of claim 1, wherein selecting the robotic fleet from the multiple robotic fleets is performed independently of selecting the fleet management system.

8. The method of claim 1, wherein selecting the robotic fleet is performed by selecting the fleet management system from amongst multiple fleet management systems and requesting a robotic fleet recommendation from the fleet management system.

9. The method of claim 1, wherein the service request includes geolocation information of a requesting user, and wherein said dispatching includes sending the geolocation information to the fleet management system.

10. The method of claim 1, wherein said generating the user interface includes displaying a status of the robotic fleet on a map provided by the user interface.

11. The method of claim 1, wherein said generating the user interface includes displaying availability indicators for robotic fleets or individual robots in the robotic fleet.

12. The method of claim 1, further comprising:
requesting, by the computer-implemented dispatch system via the user interface, a user confirmation of arrival of the robot or completion of the service request.

13. The method of claim 1, further comprising:
updating, by the computer-implemented dispatch system, the status of the service request by comparing a geolocation of a requesting device and a geolocation of the robot as reported from the fleet management system.

14. A computer-implemented method comprising:
receiving, by a robot dispatch system, a service request to utilize a robot-implemented functionality;
selecting, by the robot dispatch system, a robotic fleet from amongst multiple robotic fleets and a fleet management system associated with the robotic fleet to complete the service request;
dispatching, by the robot dispatch system, a robot from the robotic fleet by sending a command to the fleet management system; and
obtaining, by the robot dispatch system, a progress update from the fleet management system,
wherein the progress update specifies progress of the robot in fulfilling the service request.

15. The computer-implemented method of claim 14, further comprising:
generating, by the robot dispatch system, a user interface through which a user is able to monitor progress of the robot in completing a task specified by the service request.

16. The computer-implemented method of claim 15, wherein the service request is submitted by a user via a user interface accessed on a requesting device.

17. The computer-implemented method of claim 16, further comprising:
determining, by the robot dispatch system, the progress of the robot in completing the task specified by the service request by comparing a geolocation of the requesting device and a geolocation of the robot.

18. The computer-implemented method of claim 18, wherein the geolocation of the robot is reported to the robot dispatch system by the fleet management system.

19. The computer-implemented method of claim 18, wherein the geolocation of the requesting device is embedded within the service request.

20. A system for dispatching robot service requests, the system comprising:
a processor operable to execute instructions stored in a memory; and
the memory storing specific instructions that, when executed by the processor, cause the processor to:
receive a service request to utilize at least a robot-implemented functionality;
select a robotic fleet from amongst multiple robotic fleets and a fleet management system associated with the robotic fleet to complete the service request;
dispatch at least a robot from the robotic fleet by sending a command to the fleet management system associated with the robotic fleet;
obtain a progress update of the robot from the fleet management system; and
generate a user interface to monitor a status of the service request.
